(19) United States
(12) Patent Application Publication
(10) Pub. No.: US 2018/0204668 A1
(43) Pub. Date: Jul. 19, 2018

(54) Stationary Induction Apparatus

(71) Applicant: Hitachi, Ltd., Tokyo (JP)

(72) Inventors: Yasuhiro MATSUDA, Tokyo (JP); Akira YAMAGISHI, Tokyo (JP); Akira NISHIMIZU, Tokyo (JP)

(21) Appl. No.: 15/864,300

(22) Filed: Jan. 8, 2018

(30) Foreign Application Priority Data
Jan. 13, 2017 (JP) 2017-003773

(51) Int. Cl. H01F 27/33; H01F 27/08; H01F 27/02

(52) U.S. Cl. CPC H01F 27/33; H01F 27/02; H01F 27/08

(57) ABSTRACT

There is provided a stationary induction apparatus having a tank accommodating a transformer main body therein, in which a vibration suppression steel material is provided in at least a portion in the vicinity of an edge portion on a tank bottom surface. In addition, a portion of the vibration suppression steel material is made attachable and detachable.

### BACKGROUND OF THE INVENTION

### Field of the Invention

The present invention relates to a stationary induction apparatus typified by a transformer and relates to a low noise transformer which suppresses vibration of a transformer tank to reduce the radiated sound of the tank.

### Background Art

The noise of a transformer is caused by vibration of a core and a coil due to magnetostriction of the core or an electromagnetic force acting on the coil. The vibration of the core and the coil causes a bottom surface of a tank on which the core and the coil are mounted to vibrate and this vibration is transmitted to a side surface of the tank so that the vibration of the bottom surface, the side surface and a top surface of the tank is radiated to a space as noise. Although there is a countermeasure for shutting off the noise by accommodating the transformer inside a soundproofing building of concrete or iron plate in order to reduce the radiated sound from such a transformer, there are problems in this method that an installation area and manufacturing cost increase and construction period is prolonged.

In JP-A-2002-134336, there is a structure in which a reinforcing rib of a tank bottom is separated into a central portion reinforcing rib and a peripheral portion reinforcing rib and the peripheral portion reinforcing rib is fixed to a foundation. A core as a vibration source is disposed on the central portion reinforcing rib and a tank bottom plate between the central portion reinforcing rib and the peripheral portion reinforcing rib is made to have low rigidity. Accordingly, it is said that vibration transmission from the core to a tank side surface is suppressed and the radiated sound from the tank side surface is reduced.

### SUMMARY OF THE INVENTION

In the structure of fixing the entire periphery of a tank peripheral portion to a foundation in JP-A-2002-134336, since the difficulty in construction is high, there are problems that the manufacturing cost increases and the construction period is prolonged. In addition, in order to secure a strength of the tank as a pressure container while reducing the rigidity between the central portion reinforcing rib and the peripheral portion reinforcing rib, it is necessary to increase the thickness of a tank bottom plate to ensure the strength and there is a problem that to increase the thickness contradicts the reduction in the rigidity between the central portion reinforcing rib and the peripheral portion reinforcing rib.

In addition to this, the natural frequency of the tank is very large and thus it is extremely difficult to predict all the natural frequency at a design stage. As a result, in a case where a frequency of an exciting force acting on the core and the coil during actual operation coincides with the natural frequency of the tank, there is a problem that the tank resonates and the radiated sound increases.

According to the invention, there is provided a stationary induction apparatus having a tank accommodating a transformer main body therein, in which a vibration suppression steel material is provided in at least a portion in the vicinity of an edge portion on a tank bottom surface.

By installing the vibration suppression steel material, transmission of vibration of the tank bottom surface to a side surface of the tank is suppressed, the vibration of the side surface of the tank is reduced, and thus the noise is reduced.

### BRIEF DESCRIPTION OF THE DRAWINGS

FIG. 1 is a perspective view of a stationary induction apparatus according to Example 1 as viewed from below.

FIG. 2 is a cross-sectional view of Example 1.

FIG. 3 is a schematic diagram of a structure in which a vibration suppression steel material is not installed.

FIG. 4 is a schematic diagram of Example 1 in which the vibration suppression steel material is installed.

FIG. 5 is a schematic diagram of a prior art document.

FIG. 6 is an example of a vibration analysis result of Example 1.

FIG. 7 is an example of an acoustic analysis result of Example 1.

FIG. 8 is a perspective view of a stationary induction apparatus in Example 2 as viewed from above.

FIG. 9 is an enlarged view of a broken line portion of FIG. 8.

FIG. 10 is a cross-sectional view of FIG. 9.

FIG. 11 is a partial cross-sectional view of a stationary induction apparatus of Example 3.

FIG. 12 is a partial cross-sectional view of a stationary induction apparatus of Example 4.

### DETAILED DESCRIPTION OF THE INVENTION

Hereinafter, embodiments of the present invention will be described in detail with reference to the drawings.

### EXAMPLE 1

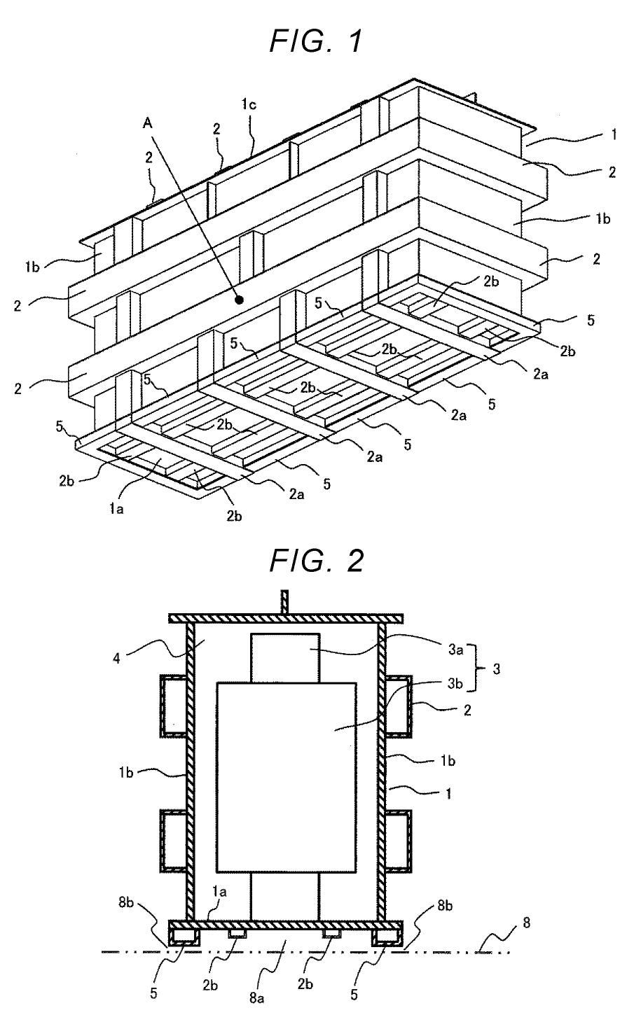

Example 1 will be described with reference to FIG. 1 to FIG. 7.

FIG. 1 is a perspective view of a stationary induction apparatus according to Example 1 as viewed from below. FIG. 2 is a cross-sectional view of Example 1.

In the stationary induction apparatus of FIG. 1, a stay 2 for securing a strength of a tank 1 as a pressure vessel is installed by welding on an outer surface of the tank 1 accommodating a transformer main body 3 therein and having a substantially rectangular parallelepiped shape. Since it is possible to suppress increase in weight by installing the stay 2 rather than securing the strength simply by thickening the thickness of the tank 1 and the manufacturing cost can be reduced, in this example, although an U-shaped stay 2 is installed, if the strength is sufficient, it is not necessary to install the stay. In addition, the structure of the stay 2 is not limited to the U-shape. The stay 2 is installed on each of a bottom surface 1a, a side surface 1b, and a top surface 1c of the tank 1 and is disposed at an inner position of the surfaces, not the edge portion of each surface. This is because deformation in an out-of-plane direction can be effectively suppressed by disposing the stay at the inner position of the surfaces. There are two kinds of stays 2 installed on the bottom surface 1a: a grounding stay 2a and a bottom stay 2b. The grounding stay 2a is in contact with a foundation surface 8 and the bottom stay 2b is spaced apart from the foundation surface 8. The material of the tank 1 and the stay 2 uses iron.

In the stationary induction apparatus of FIG. 2, the transformer main body 3 and a cooling medium 4 accommodated in the tank 1 are illustrated. The transformer main body 3 is disposed on the bottom surface 1a in the tank 1 and is configured of a core 3a, a coil 3b, and the like. In addition, the interior of the tank 1 is filled with a cooling medium 4.

In the stationary induction apparatus, the transformer main body 3 is vibrated by the magnetostriction of the core 3a and an electromagnetic force acting on the coil 3b. This vibration causes the bottom surface 1a of the tank 1 to vibrate and is transmitted to the side surface 1b, and the vibrations of the bottom surface 1a and the side surface 1b are radiated to a space as noise.

In Example 1, a vibration suppression steel material 5 is installed by being welded to the bottom surface 1a of the tank 1. An installation position thereof is in the vicinity of a joint portion with the side surface 1b of the bottom surface 1a over the entire periphery of an edge portion of the bottom surface 1a and is between the grounding stays 2a and the grounding stay 2a which are installed in plural. As illustrated in FIG. 2, the shape of the vibration suppression steel material 5 is U-shaped. In addition, the vibration suppression steel material 5 is spaced apart from the foundation surface 8.

The vibration suppression steel material 5 suppresses the transmission of the vibration of the bottom surface 1a of the tank 1 to the side surface 1b thereof, causes the vibration of the side surface 1b of the tank 1 to reduce, and reduces the noise.

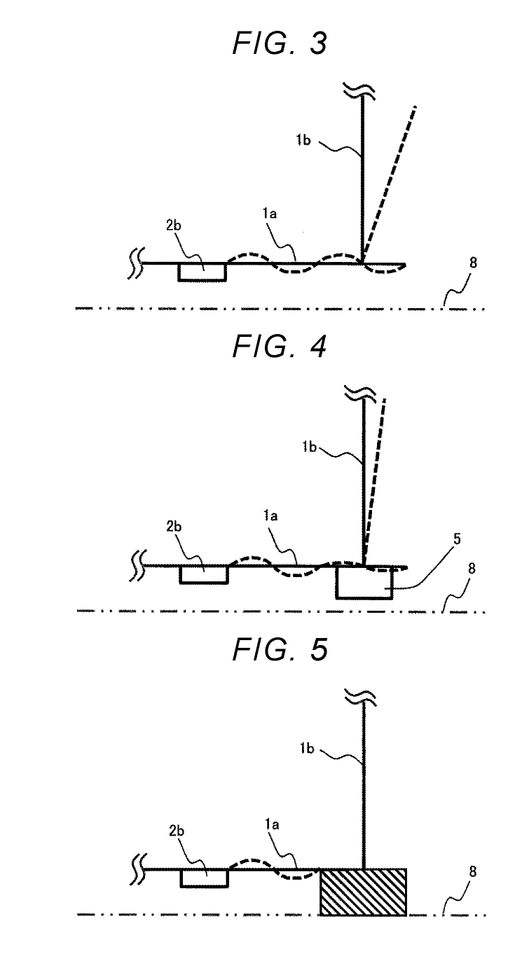

With reference to the schematic diagrams of FIG. 3 and FIG. 4, the action of reducing the vibration of the side surface 1b by the vibration suppression steel material 5 will be described. In addition, the difference between the invention and the prior art document will be explained with reference to the schematic diagram of FIG. 5.

FIG. 3 illustrates a structure in which the vibration suppression steel material 5 is not installed. In a case where the vibration suppression steel material 5 or the like is not installed, the bottom surface 1a vibrates as indicated by the broken lines, whereby the side surface 1b vibrates largely in the out-of-plane direction. On the other hand, in the structure of FIG. 4 in which the vibration suppression steel material 5 is installed, since an inclination angle of the bottom surface 1a is suppressed in the vicinity of the joint portion between the bottom surface 1a and the side surface 1b, the vibration of the side surface 1b decreases. FIG. 5 is a schematic diagram of a prior art document. In the prior art document, there is a structure in which the side surface 1b is not vibrated by the lower portion (hatched portion) of the side surface 1b being fixed to the foundation surface 8 by bolts and restrained.

As in the prior art document, despite of the effect of not vibrating the side surface 1b by the lower portion of the side surface 1b being fixed to the foundation surface 8 by bolts, since the prior art has a high degree of difficulty in construction, there is a problem that manufacturing cost increases and the construction period is prolonged. In Example 1, the vibration suppression steel material 5 installed on the bottom surface 1a of the tank 1 does not need to be fixed to the foundation surface 8. Therefore, the degree of difficulty in construction is the same as in the case where the vibration suppression steel material 5 or the like is not installed, the vibration on the side surface 1b is reduced and the noise is reduced without increasing the manufacturing cost and prolonging the construction period.

As described above, the vibration suppression steel material 5 is spaced apart from the foundation surface 8. This is because an outlet 8b of the space is not closed which is the outlet of a bottom surface space 8a between the bottom surface 1a and the foundation surface 8 illustrated in FIG. 2. The structure that closes the outlet 8b of the space is because in a case where rainwater enters, the bottom surface space is filled with the moisture, and the surface of the tank 1 in the bottom surface space 8a is rusted. Since the surface of the tank 1 is generally painted, the surface of the tank 1 is not rusted immediately but the bottom surface space is structured so as not to be closed for a guarantee of long-term reliability. Even in a case where the vibration suppression steel material 5 has such a dimension so as to be in contact with the foundation surface 8, although the vibration is reduced, since the outlet 8b of the space has a structure in which the outlet 8b of the space is closed, the vibration suppression steel material 5 is inevitably spaced apart from the foundation surface 8. However, due to the installation of the vibration suppression steel material 5, the area of the outlet 8b of the space is reduced as compared with the structure in which the vibration suppression steel material 5 is not installed. Accordingly, there is the effect of reducing the noise (noise due to vibration of bottom surface 1a) radiated to the side of the outer surface of the tank 1 from the outlet 8b of the space.

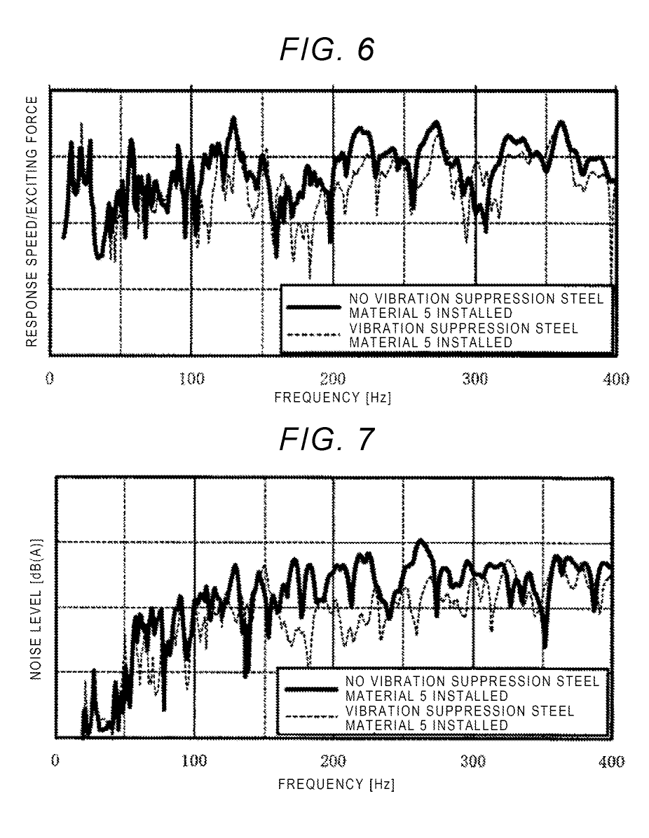

FIG. 6 and FIG. 7 are examples of a vibration analysis result and an acoustic analysis result of Example 1. In both cases, the result of not installing the vibration suppression steel material 5 is also illustrated, as a comparative target.

The vibration analysis result illustrated in FIG. 6 is a frequency response analysis result in a case where a constant exciting force is input to a core mounting portion of the bottom surface 1a of the tank 1. An observation position of the vibration response is point A in FIG. 1. Vibration is reduced by installing vibration suppression steel material 5.

The acoustic analysis result illustrated in FIG. 7 is the frequency response analysis result in which the previous vibration analysis result is input. An observation position of the sound is a spatial position which is spaced apart from the point A in FIG. 1 by 0.3 m. Noise is reduced by installing the vibration suppression steel material 5.

Although the vibration suppression steel material 5 is installed on the entire periphery of the edge portion of the bottom surface 1a, the vibration suppression steel material 5 may be installed not on the entire periphery of the edge portion but on a portion of the edge portion. Although the noise reduction effect is smaller than a case where the vibration suppression steel material 5 is installed on the entire periphery of the edge portion of the bottom surface 1a, the manufacturing cost thereof can be suppressed. In addition, the shape of the vibration suppression steel material 5 is not limited to the U-shape, and even in the case of a V shape, for example, the vibration of the side surface 1b can be reduced and low noise can be realized. In addition, the vibration suppression steel material 5 may be a solid shape filled with contents other than a hollow shape. From the viewpoint of weight saving, however, it is preferable to have a hollow shape.

According to Example 1 explained above, the installation of the vibration suppression steel material suppresses the transmission of vibration of the bottom surface to the side surface of the tank, the vibration on the side surface of the tank is reduced and the noise is reduced. In addition, by installing the vibration suppression steel material, an outlet area of the space on the bottom surface is reduced compared with the structure in which the vibration suppression steel material is not installed. Accordingly, the noise (noise due to vibration of bottom surface) radiated to the side of the tank outer surface from the outlet of the space on the bottom surface is reduced.

### EXAMPLE 2

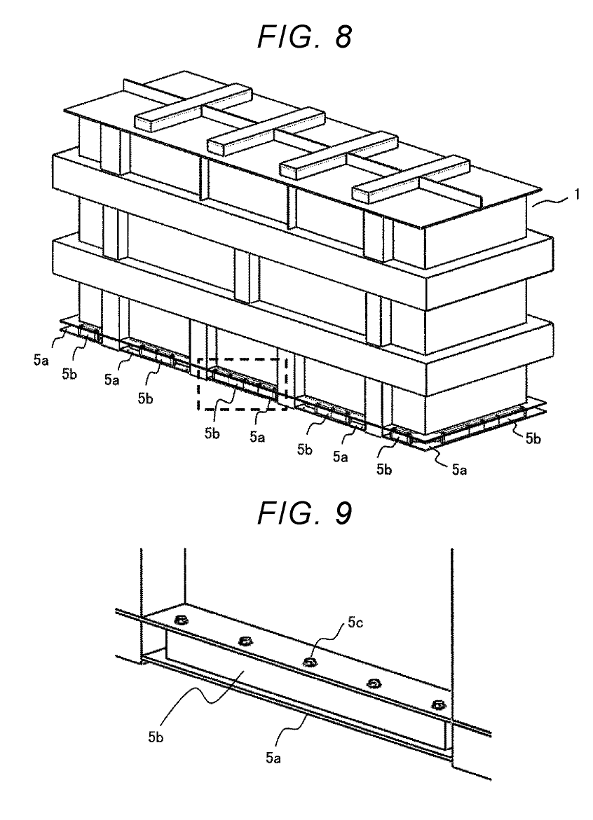

Example 2 will be described with reference to FIG. 8 to FIG. 10.

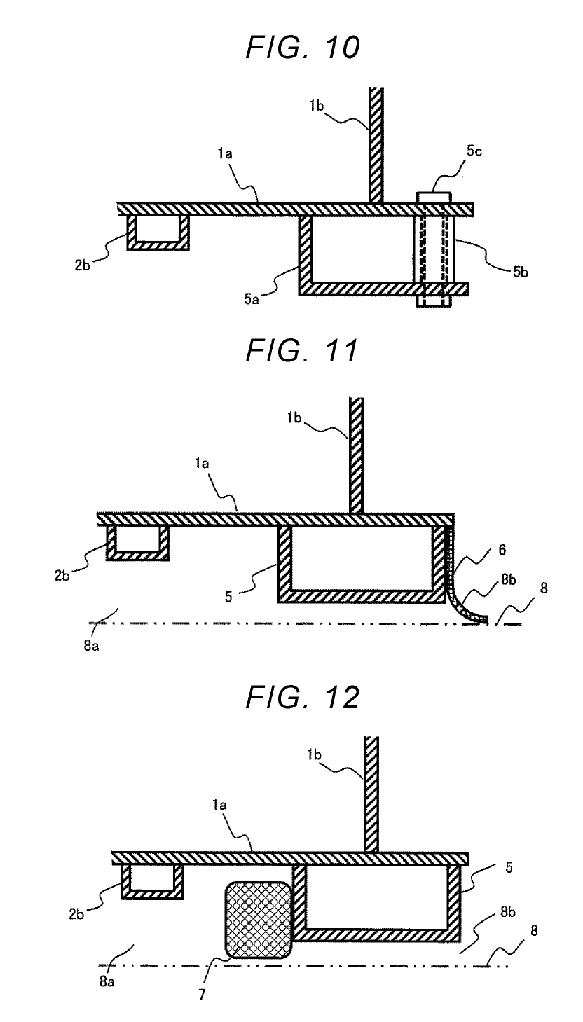

FIG. 8 is a perspective view of the stationary induction apparatus in Example 2 as viewed from above. FIG. 9 is an enlarged view of a broken line portion of FIG. 8. FIG. 10 is a cross-sectional view of FIG. 9.

In Example 2, a structure in which a portion of the vibration suppression steel material 5 is made attachable and detachable is described. A vibration suppression steel material fixing portion 5a is installed by welding and a vibration suppression steel material attachable and detachable portion 5b is fixed by a bolt 5c.

Also in Example 2, the vibration of the side surface 1b can be reduced by the same action as in Example 1 and thus noise can be reduced.

In addition, the vibration suppression steel material attachable and detachable portion 5b can be replaced with one having different thickness dimension and length dimension. By replacing with one having different thickness dimension and a length dimension, the mass and the rigidity of the vibration suppression steel material attachable and detachable portion 5b can be changed. This makes it possible to change the natural frequency of the tank 1. This makes it possible to avoid resonance due to the coincidence between the exciting frequency of the core 3a and the coil 3b and the natural frequency of the tank 1.

According to Example 2 described above, in addition to the effect of Example 1, it is made possible to change the natural frequency of the tank by making a portion of the vibration suppression steel material to be made attachable and detachable. This makes it possible to avoid resonance due to the coincidence of the frequency of the exciting force of the core and the coil and the natural frequency of the tank.

### EXAMPLE 3

Example 3 will be described with reference to FIG. 11.

FIG. 11 is a partial cross-sectional view of a stationary induction apparatus of Example 3.

In Example 3, a closing member 6 is installed in the vibration suppression steel material 5. As the material of the closing member 6, rubber or the like is used. Since closing the entire area of the outlet 8b of the space by installing the closing member 6 has a problem of being likely to be rusted by penetration of rainwater, holes, slits and the like for ventilation are provided.

In Example 3 as well, it is possible to reduce the vibration of the side surface 1b and thus low noise can be realized. In addition, since the area of the outlet 8b of the space can be reduced, there is an effect of reducing the noise (noise due to vibration of bottom surface 1a) radiated to the side of the outer surface of the tank 1 from the outlet 8b of the space.

Further, in this example, the bottom surface space 8a and the outlet 8b of the space constitute a silencer based on the principle of Helmholtz. The sound deadening characteristics are determined by the volume of the bottom surface space 8a, and the cross-sectional area and the length of the outlet 8b of the space. This silencer has an effect of reducing radiated sound due to vibration of the side surface 1b of the tank 1.

### EXAMPLE 4

Example 4 will be described with reference to FIG. 12.

FIG. 12 is a partial cross-sectional view of a stationary induction apparatus according to Example 4.

In Example 4, a sound absorbing material 7 is installed on the bottom surface 1a. By the sound absorbing material 7, the noise of the bottom surface space 8a can be absorbed and the noise can be reduced. Generally, the sound absorbing material 7 has a different sound absorbing rate with respect to the frequency of noise depending on the material. In this example, a material having a high sound absorbing rate with respect to the exciting frequency of the transformer is preferable. In addition, it is preferable that the sound absorbing material 7 is disposed at a position where the vibration velocity of air particles is high. In the present example, the sound absorbing material 7 is disposed at a position close to the outlet 8b of a space narrower than the bottom surface space 8a.

In Example 4 as well, the vibration of the side surface 1b can be reduced and thus low noise can be realized. In addition, since the noise of the bottom surface space 8a can be absorbed and the noise can be reduced, there is an effect of reducing the noise (noise due to vibration of bottom surface 1a) radiated to the side of the outer surface of the tank 1 from the outlet 8b of the space.

The invention is not limited to the examples described above but includes various modification examples. For example, the examples described above have been described in detail in order to explain the invention in an easy-to-understand manner and are not necessarily limited to those having all the configurations described. In addition, it is possible to replace a portion of the configuration of certain example with the configuration of another example and the configuration of another example can be added to the configuration of certain example. In addition, it is possible to add, delete, and replace other configurations with respect to a portion of the configuration of each example.

What is claimed is:

1. A stationary induction apparatus having a tank accommodating a transformer main body which includes a core and a coil which is wound around the core, and a cooling medium therein,
wherein a vibration suppression steel material is provided in at least a portion in the vicinity of an edge portion on a tank bottom surface.

2. The stationary induction apparatus according to claim 1,
wherein the vibration suppression steel material has a U shape.

3. The stationary induction apparatus according to claim 1,
wherein the vibration suppression steel material has a V shape.

4. The stationary induction apparatus according to claim 1,
wherein a portion of the vibration suppression steel material is made attachable and detachable.

5. The stationary induction apparatus according to claim 2,
wherein a portion of the vibration suppression steel material is made attachable and detachable.

6. The stationary induction apparatus according to claim 3,
wherein a portion of the vibration suppression steel material is made attachable and detachable.

7. The stationary induction apparatus according to claim 4,
wherein the vibration suppression steel material is configured of a vibration suppression steel material fixing portion, a vibration suppression steel material attachable and detachable portion which is made attachable and detachable, and a bolt which fixes the vibration suppression steel material attachable and detachable portion.

8. The stationary induction apparatus according to claim 5,
wherein the vibration suppression steel material is configured of a vibration suppression steel material fixing portion, a vibration suppression steel material attachable and detachable portion which is made attachable and detachable, and a bolt which fixes the vibration suppression steel material attachable and detachable portion.

9. The stationary induction apparatus according to claim 6,
wherein the vibration suppression steel material is configured of a vibration suppression steel material fixing portion, a vibration suppression steel material attachable and detachable portion which is made attachable and detachable, and a bolt which fixes the vibration suppression steel material attachable and detachable portion.

10. The stationary induction apparatus according to claim 1,
wherein the vibration suppression steel material and a foundation surface on which the tank is installed are spaced apart to each other.

11. The stationary induction apparatus according to claim 2,
wherein the vibration suppression steel material and a foundation surface on which the tank is installed are spaced apart to each other.

12. The stationary induction apparatus according to claim 3,
wherein the vibration suppression steel material and a foundation surface on which the tank is installed are spaced apart to each other.

13. The stationary induction apparatus according to claim 1,
wherein a closing member is provided in at least a portion of an outlet portion of a space at the tank bottom surface.

14. The stationary induction apparatus according to claim 2,
wherein a closing member is provided in at least a portion of an outlet portion of a space at the tank bottom surface.

15. The stationary induction apparatus according to claim 3,
wherein a closing member is provided in at least a portion of an outlet portion of a space at the tank bottom surface.

16. The stationary induction apparatus according to claim 1,
wherein a sound-absorbing material is provided in at least a portion of a space at the tank bottom surface.

17. The stationary induction apparatus according to claim 2,
wherein a sound-absorbing material is provided in at least a portion of a space at the tank bottom surface.

18. The stationary induction apparatus according to claim 3,
wherein a sound-absorbing material is provided in at least a portion of a space at the tank bottom surface.
